(19) United States
(12) Patent Application Publication
(10) Pub. No.: US 2010/0072007 A1
(43) Pub. Date: Mar. 25, 2010

(54) MACHINE TOOL, PRODUCTION MACHINE AND/OR HANDLING MACHINE

(75) Inventor: Ronald Hauf, Mohrendorf (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUNCHEN (DE)

(21) Appl. No.: 12/447,764

(22) PCT Filed: Oct. 5, 2007
(86) PCT No.: PCT/EP07/60608

§ 371 Date: Apr. 29, 2009

(30) Foreign Application Priority Data
Oct. 30, 2006 (DE) 10 2006 051 141.7

(51) Int. Cl. F16D 65/14

(52) U.S. Cl. 188/110; 188/156

(57) ABSTRACT

The invention relates to a machine tool, a production machine and/or a maintenance machine (16), comprising an electromagnetic brake (1) provided with an electrical actuator (2) for braking a mobile machine element (11, 13), the actuator (2) generating an actuating force (FB) and acting on a frictional element (7a, 7b) in such a way as to press the same against a counter frictional element (8) in order to generate a frictional force (FB). An arrangement (17, 18) is provided between the counter frictional element (8) and the electrical actuator (2), said arrangement leading to the self-energising of the actuating force (FB) generated by the electrical actuator (2). The machine comprises a device (6) for controlling the actuator (2) in such a way that the frictional force (FB) is adjusted to a nominal quantity (FRsoll). The invention relates to a machine tool, a production machine and/or a maintenance machine comprising a reliable brake (1) with a simple structure for braking a machine element (11, 13).

The invention relates to a machine tool, a production machine and/or a handling machine.

Safety technology gained considerably in significance when the EU Machinery Directive came into force in 1995. The Directive has been adopted in national legislation in all European states and is consequently binding for all machine manufacturers in the EU. In countries outside Europe, comparable requirements often arise indirectly from national product liability laws (for example the USA and Japan). Safety technology is consequently the focal point of the global market. This fact leaves the market with a need for machine tools, production machines and handling machines that make it possible to comply with technical safety regulations in a simple and reliable way.

In the case of the aforementioned machines, it is common commercial practice to use highly dynamic drives, in particular linear drives. The mechanics, motors, converters and control systems of the machines are at an advanced stage of development. The mechanical friction in the guides has in the meantime been reduced to such an extent that in an emergency it cart, in particular must, be ignored as a braking torque. In the event of the movement suffering a total drive failure, damage to machine elements when the machine axis travels at relatively high speed against an end stop is often unavoidable without the use of an emergency brake, since the kinetic energy that is present in the system is not reduced in a controlled manner. Even with reduced traveling speeds, for example during set-up operation, inadmissibly high slowing-down distances may occur and put the operator at risk. This is to be seen independently of whether vertical or horizontal machine axes are concerned. As part of risk analysis, the machine manufacturer must take suitable measures to minimize the risk.

In the case of machines with electrical drives, a distinction is made between the following types of brakes:

Holding Brake:

A holding brake is generally only closed when the machine axis is at a standstill, in order to hold the machine axis after the drive of the machine axis has been switched off. The braking torque of the holding brake is too small for rapidly bringing the machine axis to a standstill. Furthermore, the holding brake can also only withstand emergency braking from a moving state a few times.

Operating Brake:

The operating brake is generally implicitly integrated in the drive. If the machine axis is to be braked, the power converter that activates the motor is switched over and the energy flow is reversed. The motor performs generative braking and consequently loses its kinetic energy. The operating brake serves for braking the drive axis during normal operation.

Emergency Brake:

The emergency brake is generally built directly on the load and is only used for braking in an emergency. The emergency brake produces the required braking torque to stop the machine axis as quickly as possible, it generally being intended to avoid damage to machine elements as far as possible during the braking operation. An emergency occurs, for example, if there is a total failure of the drive (for example due to a fault in the power converter) and the operating brake is consequently no longer working.

German Offenlegungsschrift DE 198 19 564 A1 discloses a self-energizing electromechanical brake for use in vehicles.

Furthermore, the self-energizing electromechanical brake described above is also known from the document “Innovative Brake Technology”, February 2004, eStop GmbH.

The invention is based on the object of providing a machine tool, a production machine and/or a handling machine with a brake that is reliable and of a simple construction for braking a machine element.

This object is achieved by a machine tool, a production machine and/or a handling machine, wherein the machine has an electromechanical brake with an electrical actuator for braking a movable machine element, wherein the actuator generates an actuating force and acts on a frictional element to press it against a counter frictional element to induce a frictional force, wherein an arrangement which leads to the self-energizing of the actuating force generated by the electrical actuator is present between the counter frictional element and the electrical actuator and wherein the machine has a device which activates the actuator in such a way that the frictional force is adjusted to a desired variable.

Advantageous forms of the invention are provided by the dependent claims.

It proves to be advantageous if the frictional element carries out a linear movement during the braking operation, since linear movement operations often take place in the case of machine tools, production machines and/or handling machines.

Furthermore, it proves to be advantageous if the counter frictional element is immovably fastened.

Furthermore, it proves to be advantageous if the counter frictional element carries out a linear movement during the braking operation, since linear movement operations often take place in the case of machine tools, production machines and/or handling machines. It goes without saying, however, that the converse mechanical situation is also conceivable, i.e. that the frictional element is immovably fastened, for example to the machine, and the counter frictional element carries out a linear movement during the braking operation.

Furthermore, it proves to be advantageous if the brake is formed as an emergency brake, which carries out braking in cases of emergency. Forming the brake as an emergency brake, which preferably carries out braking in emergencies, is particularly advantageous, since reliable braking must be ensured specifically in cases of emergency.

Furthermore, it proves to be advantageous if a sensor for measuring the actuating force is arranged between the actuator and the arrangement, the frictional force being determined from the measured actuating force. This provides a possibility for determining the frictional force in a simple manner.

Furthermore, it proves to be advantageous if the desired variable has such a value that abrupt blocking of the brake during a braking operation is avoided. This allows damage to machine elements to be avoided.

Furthermore, it proves to be advantageous if the actuator is formed as an electric motor or as a plunger coil. Forming the actuator as an electric motor or a plunger coil represents a particularly simple form of the actuator.

Furthermore, it proves to be advantageous if the brake is formed as a guide rail brake or rod brake. It is normal commercial practice to use guide rail brakes or rod brakes on machine tools, production machines and/or handling machines.

Furthermore, it proves to be advantageous if, in the event of an electrical voltage failure of the actuator and/or of the device, the brake automatically carries out a braking operation, since safe braking of the machine element is thereby ensured even in the event of an electrical voltage failure.

Furthermore, it proves to be advantageous if the activation of the actuator takes place by means of the device using dependable technology. Particularly reliable functioning of the brake is made possible as a result.

Two exemplary embodiments of the invention are explained in more detail below and are represented in the drawing, in which:

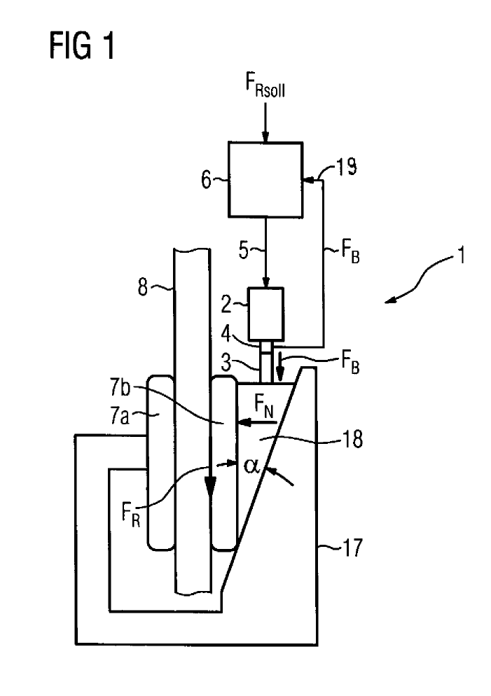

FIG. 1 shows a brake and a device,

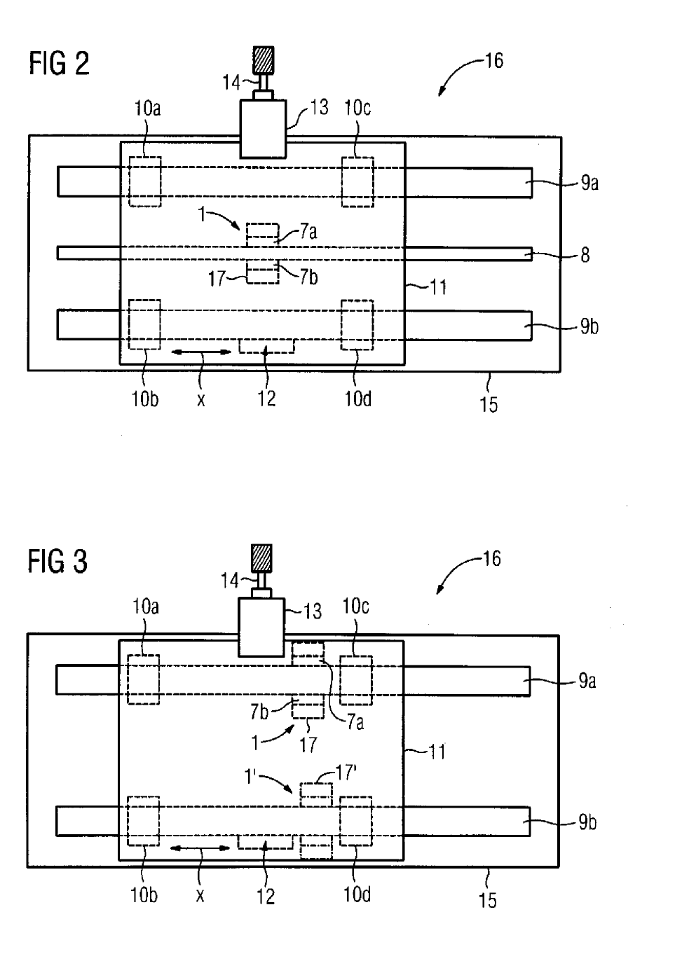

FIG. 2 shows a form of a machine tool according to the invention,

FIG. 3 shows a further form of a machine tool according to the invention and

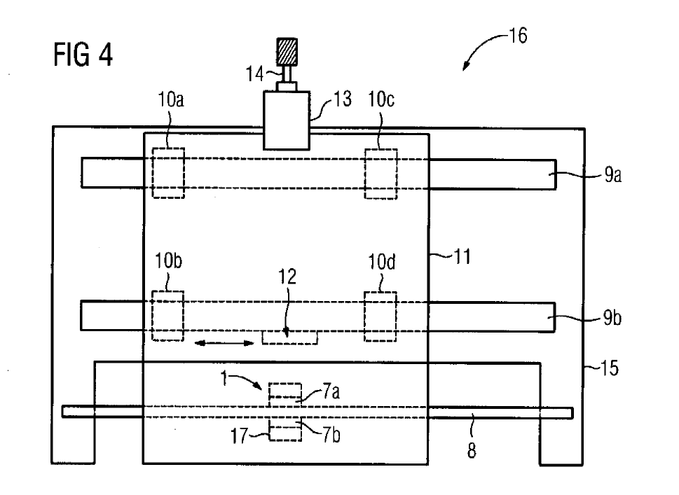

FIG. 4 shows a further form of a machine tool according to the invention.

In FIG. 1, an electromagnetic brake 1 and a device 6 which activates the electromagnetic brake 1 are represented in the form of a schematized drawing. Within the scope of the exemplary embodiment, the device 6 is in the form of a closed-loop control device with an integrated power converter for providing a supply voltage for an actuator 2. It goes without saying, however, that the power converter may also be realized as an external component.

The device 6 activates the actuator 2, which is represented by an arrow 5. The actuator 2 acts via a cylinder 3 on a wedge 18 and moves the latter in a way corresponding to the activating signal of the device 6 upward or downward in the representation according to FIG. 1. The actuator 2 may in this case be realized in the form of an electric motor or as a plunger coil. For moving the wedge 18, the actuator 2 generates an actuating force F_{B}, which acts on the wedge 18 via the cylinder 3. The actuating force F_{B} is measured by a sensor 4, which is arranged between the actuator 2 and the wedge 18, and fed to the device 6 as an input variable for controlling the actuating force F_{B} as a controlled actual variable, which is represented by a wedge 18. The wedge 18 has an angle of slope α.

When the actuating force acts on the wedge 18, the latter is pressed downward along the shaped element 17 and this produces a normal force F_{N}, which acts on a frictional element 7b and presses the latter against a counter frictional element 8 to induce a frictional force F_{R}. The wedge 18 and the shaped element 17 thereby form within the scope of the exemplary embodiment an arrangement which leads to the self-energizing of the actuating force F_{B} that is generated by the electrical actuator 2. Consequently, only a relatively small actuating force F_{B} is necessary to generate a high frictional force F_{R}.

The following relationship applies to the frictional force F_{R} with which the brake brakes:

$${F}_{R} = \frac{- {F}_{B}}{( 1 - \frac{tan ( α )}{μ} )} \qquad ( 1 )$$

μ: friction coefficient
α: angle of slope

The principle of the self-energizing electromagnetic brake described above is already known in the case of rotating components to be braked for the braking of prior art vehicles and from the documents cited at the beginning.

The use of such a brake for braking machine elements, in particular for braking machine elements of a machine tool, a production machine and/or a handling machine, in particular the use of such a brake as an emergency brake in the case of such machines, is not known.

In FIG. 2, a machine tool 16 in which the brake is fitted is represented. The machine tool 16 is represented in FIG. 2 in a schematized manner, only the components of the machine tool 16 that are necessary for understanding the invention being represented. The machine tool 16 has a fixed machine bed 15, on which two guide rails 9a and 9b and a counter frictional element 8 are fixedly mounted. Four guide shoes 10a, 10b, 10d and 10c are fixedly mounted on a machine element, which within the scope of the exemplary embodiment is in the form of the carrier plate 11. In combination with the guide rail 9a and the guide rail 9b, the guide shoes from a guide for guiding a linear movement of the carrier plate 11 in the X direction. For carrying out a traveling movement of the carrier plate 11 in an automated manner, attached to the carrier plate 11 is a linear motor 12, i.e. more precisely the movable part of the linear motor. Attached on the carrier plate 11 is a drive 13, which serves for driving a milling cutter 14.

Furthermore, the machine tool 16 has the brake 1, already described above, with the two frictional elements 7a and 7b, which may for example be in the form of brake shoes. The counter frictional element 8 is realized within the scope of the exemplary embodiment in the form of a rail, the frictional element 8 being fixedly connected to the machine bed 15 and as such immovably connected to the machine bed 15. The shaped element 17 is fixedly connected to the carrier plate 11.

During normal operation, braking is carried out by the linear motor 12, by means of the energy reversal described at the beginning.

If an emergency occurs, such as for example a fault within the power electronics which activate the linear motor 12, the movement of the carrier plate 11, and consequently the movement of the drive 13 and of the milling cutter 14, can no longer be stopped by means of the linear motor 12, which in the normal case is used as the operating brake, as a result of which machine elements, such as for example the drive 13, or persons are put at risk.

If an emergency occurs, braking can still be carried out with the aid of the brake 1. The brake is as such formed as an emergency brake, which carries out braking in cases of emergency. At the same time, however, the emergency brake may also be used as a holding brake, thereby dispensing with the need for the holding brake that is used as normal commercial practice and is only suitable for holding the machine axis when the drive is switched off. Within the scope of the exemplary embodiment, the frictional elements 7a and 7b carry out a linear movement during the braking operation. The counter frictional element 8 is in this case immovably fastened. Alternatively, it is of course also possible for the counter frictional element to be fastened for example on the carrier plate 11 and as such to carry out a linear movement during the braking operation, while the frictional elements are fixedly connected to the machine bed 15.

It goes without saying that it is also possible for the counter frictional element not to carry out a linear movement but a rotating movement, so that the brake can also brake rotating machine axes, in particular rotating machine elements.

Particularly advantageously, a sensor 4 for measuring the actuating force F_{B} is arranged between the actuator 2 and the wedge 18, the frictional force F_{R} being calculated by the device 6 from the measured actuating force F_{B}, by means of the relationship 1, as a controlled actual variable for controlling the actuating force F_{B}. This makes it possible to dispense with complex direct measurement of the frictional force F_{R}.

The desired variable F_{Rsoll}, which serves as a controlled desired variable for controlling the actuating force F_{B}, has in this case such a value that abrupt blocking of the brake during a braking operation is avoided. This allows damage to the machine as a result of excessive braking deceleration to be avoided.

The desired variable F_{Rsoll} may in this case have a fixed value or else the desired variable may be prescribed for example in accordance with the speed and mass of the machine elements of the machine that are to be braked, for example by an open-loop control of the device 6. It goes without saying, however, that it is also possible for the means necessary for determining the desired variable F_{Rsoll} to be integrated in the device 6. The device 6 need not necessarily be a purely closed-loop control device but may also be a combined closed-loop and open-loop control device.

In order, for example, in the event of failure of the complete supply voltage of the machine, also to make safe braking of the machine element still possible, in the event of an electrical voltage failure of the device 6, a braking operation is automatically carried out by the brake. For this purpose, the actuator 2 has a mechanical energy-storing element, such as for example a spring element, in particular a spring. The spring may be kept in the tensioned state, for example by electromagnets arranged inside the actuator 2. If the supply voltage of the actuator 2 and/or of the device 6 fails, the brake automatically carries out a braking operation, in which the spring presses on the cylinder 3 and as such generates an actuating force F_{B} on the wedge 18. The device and as such the activation of the actuator are in this case configured using dependable technology, i.e. for example technology certified by corresponding certification agencies.

In FIG. 3, a further form of the invention is represented. The embodiment represented in FIG. 3 corresponds in its basic setup substantially to the embodiment described above in FIG. 2. The same elements are therefore provided with the same reference numerals in FIG. 3 as in FIG. 1. The only major difference is that, in the case of the embodiment according to FIG. 3, the counter frictional element is in the form of the guide rail 9a. The guide rail 9a consequently assumes both the function of the counter frictional element of the brake 1 and the guidance of the moving machine elements. The brake is as such formed as a guide rail brake. To avoid undesired torques, it is advisable for the guide rail 9b also to be provided with a brake 1′ identical to the brake 1.

In FIG. 4, a further embodiment of the invention is represented. The embodiment represented in FIG. 4 corresponds in its basic setup substantially to the embodiment described above in FIG. 2. The same elements are therefore provided with the same reference numerals in FIG. 4 as in FIG. 2. The only major difference is that, in the case of the embodiment according to FIG. 4, the counter frictional element takes the form of a rod 8′ arranged separately on the machine bed 15. The guidance of the carrier plate 11 is in this case carried out in precisely the same way as in the case of the embodiment according to FIG. 2, substantially by the guide rails 9a and 9b and the guide shoes 10a, 10b, 10c and 10d, while braking takes place by means of the rod 8′. The brake is as such formed as a rod brake.

Furthermore, the use of the electromagnetic brake makes smooth braking torque transitions possible when the brake is activated and deactivated. This saves wear and tear on the mechanical elements of the machine, which is a significant advantage over brake systems used in normal commercial practice.

1.-12. (canceled)

13. A machine tool, comprising:
a movable machine element; and
an electromechanical brake which includes
a frictional element,
a counter frictional element,
an electrical actuator for braking the machine element, said actuator generating an actuating force acting on the frictional element to press the frictional element against the counter frictional element and thereby induce a frictional force,
an arrangement disposed between the counter frictional element and the electrical actuator to cause a self-energizing of the actuating force; and
a device operatively connected to the actuator to control the actuator in such a way that the frictional force is adjusted to a desired variable, with the desired variable having a value to prevent abrupt blocking of the brake during a braking operation.

14. The machine tool of claim 13, wherein the frictional element is constructed to execute a linear movement during the braking operation.

15. The machine tool of claim 13, wherein the counter frictional element is immovably fixed.

16. The machine tool of claim 13, wherein the counter frictional element is constructed to execute a linear movement during the braking operation.

17. The machine tool of claim 13, wherein the desired variable is defined in dependence on a speed and mass of the machine element.

18. The machine tool of claim 13, wherein the brake is constructed in the form of an emergency brake which is rendered operative in the event of an emergency.

19. The machine tool of claim 13, further comprising a sensor measuring the actuating force and arranged between the actuator and the arrangement, wherein the frictional force is determined as a function of the actuating force being measured.

20. The machine tool of claim 13, wherein the actuator is constructed in the form of an electric motor or plunger coil.

21. The machine tool of claim 13, wherein the brake is constructed in the form of a guide rail brake or rod brake.

22. The machine tool of claim 13, wherein, in the event of an electrical voltage failure of the actuator or of the device, or both, the brake is constructed to automatically execute the braking operation.

23. The machine tool of claim 13, wherein the device is constructed to activate the actuator using dependable technology.

24. The machine tool of claim 13, wherein the arrangement includes a wedge movably arranged adjacent to the friction element to produce a normal force oriented perpendicular to the actuating force and directed against the friction element.
